(19) United States
(12) Patent Application Publication
(10) Pub. No.: US 2018/0009230 A1
(43) Pub. Date: Jan. 11, 2018

(54) SHAPING DEVICE, SHAPING METHOD, AND SHAPING SYSTEM

(71) Applicant: MIMAKI ENGINEERING CO., LTD., Nagano (JP)

(72) Inventors: Masaru OHNISHI, Nagano (JP); Kazuhiro OCHI, Nagano (JP)

(73) Assignee: MIMAKI ENGINEERING CO., LTD., Nagano (JP)

(21) Appl. No.: 15/638,382

(22) Filed: Jun. 30, 2017

(30) Foreign Application Priority Data
Jul. 11, 2016 (JP) 2016-136482

(51) Int. Cl. B41J 2/175; B29C 67/00; B41J 2/21

(52) U.S. Cl. CPC B41J 2/17596; B41J 2/21; B29C 67/0007; B41J 2/211; B33Y 40/00; B33Y 30/00; B29K 2995/0021

(57) ABSTRACT

A shaping device, that shapes a three-dimensional object, includes an ink jet head that discharges an ink to become a material of shaping; and an ink supplying unit that supplies a pre-toned ink, which is the ink toned in advance in accordance with a color to be colored on the 3D object, to the ink jet head, where the ink jet head forms at least one part of the 3D object while coloring the one part with the color of the pre-toned ink by discharging the pre-toned ink.

### CROSS REFERENCE TO RELATED APPLICATIONS

This application claims the priority benefit of Japanese Patent Application No. 2016-136482, filed on Jul. 11, 2016. The entirety of the above-mentioned patent application is hereby incorporated by reference herein and made a part of this specification.

### TECHNICAL FIELD

The present disclosure relates to a shaping device, a shaping method, and a shaping system.

### DESCRIPTION OF THE BACKGROUND ART

A shaping device (3D printer) that shapes a 3D object using an ink jet head is conventionally known (see e.g., Japanese Unexamined Patent Publication No. 2015-71282). In such shaping device, for example, the 3D object is shaped through a layering shaping method by overlapping a plurality of layers of ink formed by the ink jet head.

[Patent Document 1] JP 2015-71282 A

### SUMMARY

In recent years, shaping a colored 3D object, and the like by using the ink of a plurality of colors different from each other for the material of shaping are also being considered. In this case, the colored 3D object is shaped by forming a surface of the 3D object using the ink of each color of the process color, which becomes the basic color of coloring. The ink of each color of C (cyan), M (magenta), Y (yellow), and K (black), for example, is considered to be used for the ink for coloring.

In such a case, the ink of each color is landed on a surface-to-be-shaped of the 3D object by causing the ink jet head for the ink of each color to carry out a scanning operation (main scanning operation, etc.) of discharging the ink while relatively moving with respect to the 3D object being shaped. In this case, the ink of each color is sequentially landed in an order determined by the relationship of the arrangement of the ink jet heads and the direction of moving the ink jet head at the time of the scanning operation.

To efficiently carry out the shaping of the 3D object, consideration is made to carry out the main scanning operation not only in a one-way direction but also in a two-way direction such as the direction corresponding to forward path and backward path of the reciprocating operation. For example, consideration is made to carry out the reciprocate main scanning operation so as to discharge the ink in both the forward path and the backward path for the main scanning operation of moving the ink jet head in a predetermined main scanning direction. In this case, a difference is produced in the order the ink of each color is overlapped depending on the direction the ink jet head is moved. As a result, the way the color is viewed may differ depending on the position of the 3D object.

The problem that a difference is produced in the order the ink of each color is overlapped depending on the direction of moving the ink jet head in the main scanning operation, and the like similarly arises even when carrying out, for example, color printing (two-dimensional printing) with respect to a flat medium (medium) such as paper. However, at the time of shaping the 3D object, the difference in the way such color is viewed may become more significant if a plurality of layers of ink are formed in an overlapping manner.

Furthermore, the three-dimensional 3D object has a possibility of being observed from a wider variety of directions compared to the medium (two-dimensional printed matter) on which the two-dimensional printing is performed. Thus, the overlapping of the ink of each color is not necessarily observed from only the upper side, and may be observed from other directions such as the lower side of overlapping. In this case, a difference may arise in the way the color is viewed by the difference in the direction of observing the 3D object.

However, in the 3D object, if a difference is produced in the way the color is viewed by the position in the 3D object and the difference in the observing direction, a difference (color difference, color variation) arises between a target color and an actually viewed color, and coloring becomes difficult to be carried out at high precision. In particular, if such difference arises in the way the color is viewed with respect to an important portion in the 3D object, the 3D object becomes difficult to shape at high quality. More specifically, for example, when attempting to shape a figure, and the like showing a person, an unnatural impression may become strong if such difference is produced in the way the skin color of the figure is viewed, and the like. Thus, a configuration of carrying out shaping with a more appropriate method is conventionally desired for the colored 3D object. The present disclosure thus provides a shaping device, a shaping method, and a shaping system capable of solving the problem described above.

The inventor of the present application has conducted a thorough research on the method for more appropriately shaping the colored 3D object. Consideration is made to use only an ink of one color for at least one part of the 3D object (e.g., important portion etc. in the 3D object) instead of using the inks of a plurality of colors such as the ink of each color of the process color. Furthermore, consideration is made to use a pre-toned ink, which is the ink toned in advance in accordance with the color to be colored on the 3D object, for the configuration therefor. According to such configuration, for example, the difference can be appropriately prevented from being produced in the way the color is viewed by the position in the 3D object and the difference in the observing direction for at least the portion formed with the pre-toned ink. Thus, for example, the shaping can be carried out with a more appropriate method for the colored 3D object.

Furthermore, the inventors of the present application have found features necessary for obtaining such effect through more thorough research, and have contrived the present disclosure. In order to solve the problem described above, the present disclosure provides a shaping device that shapes a three-dimensional 3D object, the shaping device including an ink jet head that discharges an ink to become a material of shaping; and an ink supplying unit that supplies a pre-toned ink, which is the ink toned in advance in accordance with a color to be colored on the 3D object, to the ink jet head, where the ink jet head discharges the pre-toned ink to form at least one part of the 3D object while coloring the one part with the color of the pre-toned ink.

According to such configuration, for example, the difference can be appropriately prevented from being produced in the way the color is viewed by the position in the 3D object and the difference in the observing direction for the portion formed with the pre-toned ink. Thus, for example, the shaping can be carried out with a more appropriate method for the colored 3D object.

Furthermore, in this case, at least one part of the 3D object is preferably formed using only the pre-toned ink. The ink in which the density of the color is further adjusted in accordance with the density of the color to be colored on the 3D object, for example, is preferably used for the pre-toned ink. In this case, for example, an ink in which the color is toned by mixing an ink of a color of a plurality of chromatic colors, and in which a density of a color is adjusted by further mixing an ink for diluting the density of the color, and the like can be used for the pre-toned ink. In this case, for example, the clear ink can be suitably used for the ink for diluting the density of the color. According to such configuration, for example, the difference can be more appropriately prevented from being produced in the way the color is viewed by the difference in the position in the 3D object and the observing direction.

Furthermore, the shaping device may further include, for example, an ink toning unit. In this case, the ink toning unit has a configuration of, for example, toning the pre-toned ink using the ink of the color of at least a plurality of chromatic colors. Furthermore, in this case, the ink toning unit further preferably adjusts the density of the ink using the ink (e.g., clear ink, etc.) for diluting the density of the color. According to such configuration, for example, the toning of the pre-toned ink can be appropriately carried out.

Furthermore, the shaping device may further include a plurality of color representation heads, in addition to a pre-toned ink head, which is the ink jet head for discharging the pre-toned ink, for the ink jet head. In this case, the plurality of color representation heads are, for example, a plurality of ink jet heads respectively discharging an ink of each of a plurality of basic colors for color representation by color mixing. The respective colors of the plurality of basic colors are, for example, each color of the process color. Each color of the process color is, for example, each color of C (cyan), M (magenta), Y (yellow), and K (black).

In this case, at least one part of the 3D object is formed while coloring the one part with the color of the pre-toned ink by the pre-toned ink head. Furthermore, at least another part of the 3D object is formed while coloring using the inks of a plurality of basic colors by the plurality of color representation heads.

Moreover, in this case, for example, a difference can be more appropriately prevented from being produced in the way the color is viewed by the difference in the position in the 3D object and the observing direction for, for example, the important portions, and the like by using the pre-toned ink for the important portions, and the like in the 3D object. The 3D object thus can be appropriately shaped with a high quality. Various colors can be appropriately represented by forming the other portions using the inks of the plurality of basic colors rather than using the pre-toned ink. Thus, for example, the 3D object performed with a wide variety of coloring using various colors can be more appropriately shaped with a high quality.

Furthermore, in this case, for example, consideration is made to form the portion where a wide area is colored with the same color in the 3D object with the pre-toned ink. More specifically, for example, when shaping a figure, which is a 3D object showing a person, and the like, consideration is made to use the pre-toned ink toned to show the color of the skin of the person. According to such configuration, for example, the 3D object such as the figure can be appropriately shaped at high quality.

The shaping device may also use, for example, the pre-toned ink of a plurality of colors different from each other. In this case, the shaping device includes a plurality of pre-toned ink heads. Furthermore, regions different from each other in the 3D object are formed by each pre-toned ink heads. Moreover, consideration is made to use the ink formed by mixing a plurality of inks in which any property other than the color is different from each other for the pre-toned ink. In this case, the pre-toned ink becomes the ink in which the property other than color is further adjusted. According to such configuration, for example, even the property other than the color can be appropriately adjusted according to the desired quality. Thus, for example, the 3D object of high quality can be more appropriately shaped. Furthermore, in this case, the pre-toned ink may be considered as the pre-adjusted ink in a more generalized manner, focusing on the property other than the color.

Use of the shaping method, the shaping system, and the like having characteristics similar to the above is also considered for the configuration of the present disclosure. In such cases as well, for example, effects similar to the above can be obtained.

According to the present disclosure, for example, the shaping can be carried out with a more appropriate method for the colored 3D object.

### BRIEF DESCRIPTION OF THE DRAWINGS

FIGS. 1A and 1B are views describing a shaping system 10 including a shaping device 100 according to one embodiment of the present disclosure. FIG. 1A shows one example of a configuration of the shaping system 10. FIG. 1B is a cross-sectional view showing one example of a configuration of a 3D object 50 shaped by the shaping device 100 along with a support layer 70.

FIGS. 2A and 2B are views describing one example of the shaping device 100. FIG. 2A shows one example of a configuration of a main part of the shaping device 100. FIG. 2B shows one example of a more detailed configuration of a head unit 102.

FIGS. 3A and 3B are views describing a pre-toned ink in further detail. FIG. 3A shows one example of a configuration of an ink toning unit 200 that carries out the toning of the pre-toned ink. FIG. 3B shows one example of a configuration of the 3D object 50 shaped using the pre-toned ink.

FIGS. 4A to 4C are views describing the way the color is viewed for when color representing by the color mixing of the inks of a plurality of colors. FIG. 4A is a view showing one example of an operation of carrying out shaping while coloring using the ink jet heads 202c to 202k for each color of CMYK. FIG. 4B is a view showing one example of a relationship of an overlapping manner of the dot of the ink of the different color, and the way the color is viewed. FIG. 4C is a view showing one example of a configuration of a polyhedral 3D object 50.

### DETAILED DESCRIPTION OF EMBODIMENTS

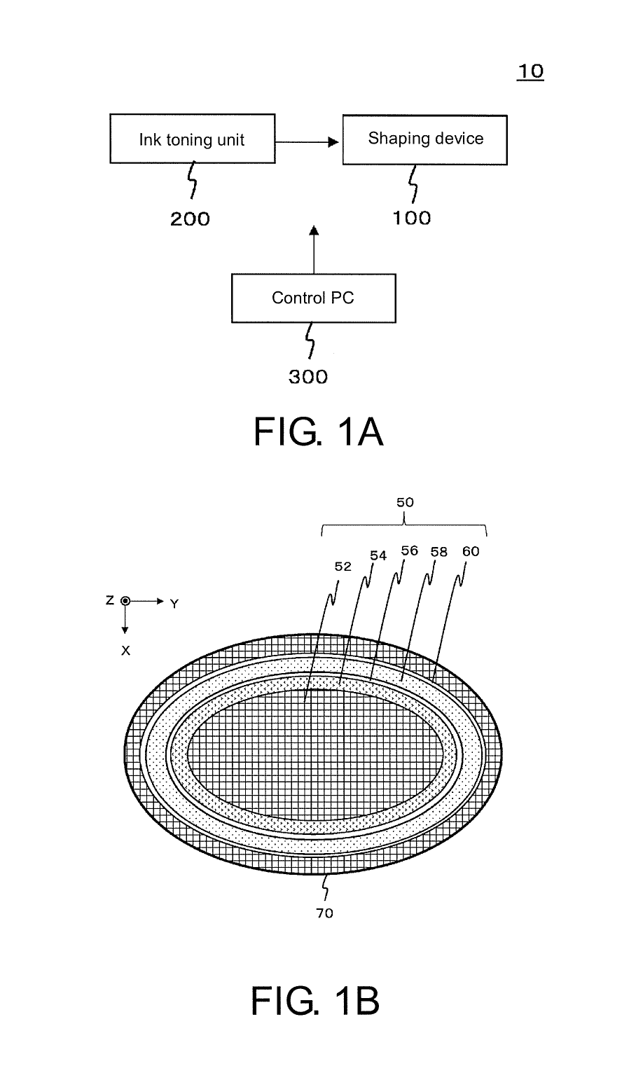

Hereinafter, an embodiment according to the present disclosure will be described with reference to the drawings. FIGS. 1A and 1B are views describing a shaping system 10 including a shaping device 100 according to one embodiment of the present disclosure. FIG. 1A shows one example of a configuration of the shaping system 10.

In the present example, the shaping system 10 is a system that shapes a three-dimensional 3D object, and includes the shaping device 100, an ink toning unit 200, and a control PC 300. The shaping device 100 is a device that executes the operation of shaping. In the present example, the shaping device 100 shapes the 3D object through the layering shaping method. In this case, the layering shaping method is, for example, a method for overlapping a plurality of layers to shape the 3D object. The 3D object is, for example, a stereoscopic three-dimensional structural object. The shaping device 100 uses an ink that cures according to a predetermined condition for the material of shaping. A more specific configuration, and the like of the shaping device 100 will be described later in further detail.

The ink toning unit 200 is a device that carries out toning of adjusting the color of at least some ink of the inks used in the shaping system 10 to a color set in advance. In this case, the ink used in the shaping system 10 is, for example, the ink used for the material of shaping. Furthermore, in the present example, the ink toning unit 200 manufactures the pre-toned ink, which is the ink toned in advance in accordance with the color to be colored on the 3D object, by toning the ink. The manufactured ink is then supplied to the shaping system 10.

The supply of the pre-toned ink from the ink toning unit 200 to the shaping device 100 is, for example, thought to be carried out by, for example, filling ink into an ink container (e.g., ink bottle, etc.) used in the shaping system 10. Furthermore, the supply of the pre-toned ink to the shaping device 100 may, for example, be carried out by filling the ink into a container for ink transportation. Moreover, for example, the ink may be directly supplied from the ink toning unit 200 to the shaping device 100 using an ink supply path such as a tube. In an alternative embodiment of the configuration of the shaping system 10, all or a part of the ink toning unit 200 may be considered as a configuration of one part of the shaping device 100. The toning of the ink carried out in the ink toning unit 200 will be described later in more detail.

The control PC 300 is a computer (host PC) that controls the operation of the shaping device 100. For example, the control PC 300 generates slice data showing a cross-section corresponding to each layer formed by a layering operation of the layering shaping method with respect to the 3D object to shape, and provides the slice data to the shaping device 100. Furthermore, the control PC 300 controls the operation of the shaping device 100. Moreover, the control PC 300 may, for example, control at least one part of the operation of the ink toning unit 200. For example, consideration is made to cause the ink toning unit 200 to carry out the toning of the pre-toned ink by notifying the color of the pre-toned ink to use in the shaping device 100 to the ink toning unit 200.

In the present example, the control PC 300 controls the operations of the shaping device 100 and the ink toning unit 200 to, for example, cause the shaping device 100 to shape the 3D object in which at least one part of a surface is colored with the color of the pre-toned ink. In this case, the surface of the 3D object is, for example, a region where the color can be visually recognized from the outside in the 3D object.

FIG. 1B is a cross-sectional view showing one example of a configuration of the 3D object 50 shaped by the shaping device 100 along with a support layer 70, and schematically shows the configuration of the cross-section of the 3D object 50 by a plane perpendicular to a layering direction (Z direction), which is a direction the material of the shaping is layered in the layering shaping method. In the illustrated case, the 3D object 50 is a three-dimensional object of an oval spherical shape. In this case, for example, the configuration of the cross-section of the 3D object 50 by the plane perpendicular to an X direction and a Y direction in the figure also becomes the same as or similar to the illustrated configuration. More specifically, in the present example, the 3D object 50 includes an internal region 52, a light reflection region 54, an internal clear region 56, a coloring region 58, and a surface clear region 60. Each of such regions is formed so as to be lined in such order in a direction from the inside to the outside of the 3D object 50.

The internal region 52 is a region (model layer) of the inside of the 3D object 50 configuring the shape of the 3D object 50. In the present example, the internal region 52 is formed using a shaping material ink, which is an ink dedicated for shaping. Furthermore, the internal region 52 may be formed using an ink other than the shaping material ink. In this case, for example, consideration is made to form the internal region 52 using various inks other than the material of the support layer 70. More specifically, for example, the internal region 52 may be formed using an ink (color ink) for coloring, and the like. Furthermore, for example, the internal region 52 may be formed using a white ink, a clear ink, and the like.

The light reflection region 54 is a region (reflection layer) having light reflectivity of reflecting the light entering from the surface side of the 3D object 50 through the coloring region 58, and the like. The coloring in a subtractive color mixing method can be appropriately carried out, for example, by forming the light reflection region 54 on the inner side of the coloring region 58. Furthermore, in the present example, the light reflection region 54 is formed using the white (W) ink.

The internal clear region 56 is a transparent region (transparent layer) formed between the light reflection region 54 and the coloring region 58. The mixing of ink can be appropriately prevented from occurring between the light reflection region 54 and the coloring region 58 by forming the internal clear region 56. In the present example, the internal clear region 56 is formed using the clear ink of colorless transparent color (T color).

The coloring region 58 is a region (color layer) to be colored by the ink for coloring. In the present example, the coloring region 58 is a layer-like region that lies along the surface shape of the 3D object 50, and is formed using at least the ink for coloring. In this case, at least the pre-toned ink described above is used for the ink for coloring. In the present example, the respective color inks of a plurality of basic colors for realizing color representation by color mixing are further used for the ink for coloring, as necessary. When using the respective color inks of the plurality of basic colors, the clear ink is further used along with such inks to form at least a part of the coloring region 58.

The respective colors of the plurality of basic colors are, for example, each color of the process color. Each color of the process color is, for example, each color of C (cyan), M (magenta), Y (yellow), and K (black). Furthermore, the ink for coloring is not limited to the inks of such colors, and the inks of other colors may be further used. For example, the ink of a specific color (e.g., white ink, etc.) of various colors may be further used.

Moreover, when further using the respective color inks of the plurality of basic colors to form the coloring region, the coloring region 58 includes, for example, a portion colored to the color of the pre-toned ink, and a portion colored to various colors using the ink of each color other than the pre-toned ink. As will be described later in further detail, in the present example, the ink in which the density of the color is further adjusted in accordance with the density of the color to be colored on the 3D object 50 is used for the pre-toned ink. In this case, the portion colored to the color of the pre-toned ink in the coloring region 58 is formed with only the pre-toned ink, without using the inks of other colors. The shaping device 100 thus forms at least one part of the coloring region 58 using only the pre-toned ink.

With regards to the portion performed with coloring in the coloring region 58, various colors are represented by adjusting the discharging amount of the ink for coloring of each color to each position in the region. In this case, a difference may arise in the amount of ink (discharging amount per unit volume) for coloring due to the difference in the color to represent. Thus, in the present example, a portion to be performed with the coloring in the coloring region 58 is formed by further using the clear ink to compensate for the change in the amount of ink for coloring caused by the difference in color. According to such configuration, for example, each position of the coloring region 58 can be appropriately colored with various colors.

The surface clear region 60 is a transparent region (transparent layer) for protecting the outer surface of the 3D object 50. Furthermore, in the present example, the surface clear region 60 is a region configuring the outermost surface of the 3D object 50, and is formed using the clear ink. The coloring region 58, and the like on the inner side, for example, can be appropriately protected by forming the surface clear region 60. Furthermore, for example, the 3D object 50 in which the surface is colored thus can be more appropriately formed.

As shown in the figure, in the present example, the support layer 70 is formed at the periphery of the 3D object 50, as necessary. In this case, the support layer 70 is, for example, a layered structural object that supports the 3D object 50 by surrounding the outer periphery of the 3D object 50 being shaped. The support layer 70 is, for example, a layer formed with a water soluble material, and is formed, as necessary, during the shaping of the 3D object 50 and removed after the shaping is completed.

The configuration of the 3D object 50 is not limited to the configuration described above, and can be variously changed. For example, consideration is made to integrally form the internal region 52 with the light reflection region 54, without distinguishing the internal region 52 from the light reflection region 54. In this case, for example, the internal region 52 and the light reflection region 54 are integrally formed using the ink having light reflectivity such as white ink. Consideration is also made to omit some region, and the like according to the quality, and the like demanded on the 3D object 50. In this case, for example, one of or both of the internal clear region 56 and the surface clear region 60 may be omitted.

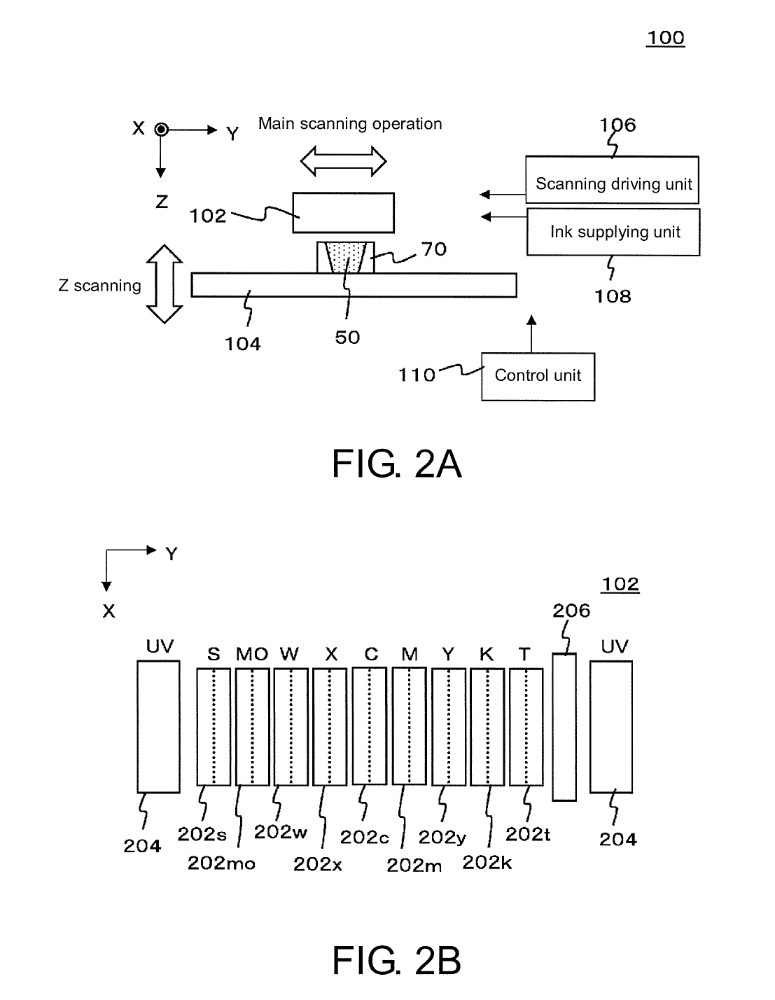

Next, a more specific configuration, and the like of the shaping device 100 will be described. FIGS. 2A and 2B are views describing one example of the shaping device 100. FIG. 2A shows one example of a configuration of a main part of the shaping device 100.

Excluding the points described below, the shaping device 100 may have a configuration same as or similar to the known shaping device. More specifically, excluding the points described below, the shaping device 100 may have a configuration same as or similar to, for example, a known shaping device that carries out shaping by discharging a liquid droplet to become the material of the 3D object 50 using the ink jet head. Furthermore, other than the illustrated configuration, the shaping device 100 may further include, for example, various types of configurations necessary for shaping, coloring, and the like of the 3D object 50.

In the present example, the shaping device 100 includes a head unit 102, a shaping table 104, a scanning driving unit 106, an ink supplying unit 108, and a control unit 110. The head unit 102 is a portion that discharges the liquid droplet to become the material of the 3D object 50, and forms each layer configuring the 3D object 50 in an overlapping manner by discharging and curing the ink that cures according to a predetermined condition. In this case, the discharging of ink means discharging of the liquid droplet (ink droplet) of the ink. Furthermore, the ink is, for example, a liquid discharged from the ink jet head. The ink jet head is, for example, a discharging head that discharges the ink droplet through an ink jet method. In the present example, the head unit 102 includes a plurality of ink jet heads, and an ultraviolet light source. The head unit 102 further discharges a liquid droplet to become the material of the support layer 70. A more specific configuration of the head unit 102 will be described in detail later.

The shaping table 104 is a table-like member that supports the 3D object 50 being shaped, and is arranged at a position facing the ink jet head in the head unit 102 and has the 3D object 50 being shaped placed on an upper surface. In the present example, the shaping table 104 has a configuration in which at least the upper surface is movable in the layering direction, where at least the upper surface is moved with the progress in the shaping of the 3D object 50 when driven by the scanning driving unit 106. Furthermore, in the present example, the layering direction is a direction (Z direction in the figure) orthogonal to a main scanning direction (Y direction in the figure) and a sub-scanning direction (X direction in the figure) set in advance in the shaping device 100.

The scanning driving unit 106 is a driving unit that causes the head unit 102 to carry out the scanning operation of relatively moving with respect to the 3D object 50 being shaped. In this case, when referring to relatively moving with respect to the 3D object 50 being shaped, this means, for example, relatively moving with respect to the shaping table 104 supporting the 3D object 50. Furthermore, when referring to causing the head unit 102 to carry out the scanning operation, this means, for example, causing the ink jet head of the head unit 102 to carry out the main scanning operation. Moreover, in the present example, the scanning driving unit 106 causes the head unit 102 to carry out the main scanning operation (Y scanning), the sub-scanning operation (X scanning), and the layering direction scanning (Z scanning).

In this case, the main scanning operation is, for example, an operation of discharging the ink while moving in the main scanning direction. Furthermore, in the present example, the scanning driving unit 106 causes the head unit 102 to carry out the main scanning operation by fixing the position of the shaping table 104 in the main scanning direction, and moving the head unit 102 side. The movement of the head unit 102 in the main scanning operation may be a relative movement with respect to the 3D object 50. Thus, in an alternative embodiment of the configuration of the shaping device 100, the 3D object 50 side may be moved by fixing the position of the head unit 102, and for example, moving the shaping table 104.

Furthermore, at the time of the main scanning operation of the present example, the scanning driving unit 106 further carries out the drive of the ultraviolet light source in the head unit 102. More specifically, the scanning driving unit 106, for example, lights the ultraviolet light source at the time of the main scanning operation to cure the ink landed on the surface-to-be-shaped (shaping layer) of the 3D object 50. The surface-to-be-shaped of the 3D object 50 is, for example, the surface where a next layer of ink is formed by the head unit 102.

The sub-scanning operation is, for example, an operation of relatively moving with respect to the shaping table 104 in the sub-scanning direction orthogonal to the main scanning direction. More specifically, the sub-scanning operation is, for example, an operation of relatively moving with respect to the shaping table 104 in the sub-scanning direction by a feeding amount set in advance. In the present example, the scanning driving unit 106 causes the head unit 102 to carry out the sub-scanning operation between the main scanning operations. In this case, the scanning driving unit 106, for example, causes the head unit 102 to carry out the sub-scanning operation by fixing the position of the head unit 102 in the sub-scanning direction and moving the shaping table 104. The scanning driving unit 106 may cause the head unit 102 to carry out the sub-scanning operation by fixing the position of the shaping table 104 in the sub-scanning direction and moving the head unit 102.

The layering direction scanning is, for example, an operation of relatively moving the head unit 102 in the layering direction with respect to the 3D object 50 by moving at least one of the head unit 102 or the shaping table 104 in the layering direction. In this case, when referring to moving the head unit 102 in the layering direction, this means, for example, moving at least the ink jet head in the head unit 102 in the layering direction. When referring to moving the shaping table 104 in the layering direction, this means, for example, moving the position of at least the upper surface in the shaping table 104. Furthermore, the scanning driving unit 106 adjusts the relative position of the ink jet head with respect to the 3D object 50 being shaped in the layering direction by causing the head unit 102 to carry out the layering direction scanning.

More specifically, in the present example, the scanning driving unit 106, for example, fixes the position of the head unit 102 in the layering direction and moves the shaping table 104. The scanning driving unit 106 may also fix the position of the shaping table 104 in the layering direction and move the head unit 102.

The ink supplying unit 108 has a configuration of supplying ink to a plurality of ink jet heads in the head unit 102, and supplies the ink of each color to use for shaping to each of the plurality of ink jets. The ink of a plurality of colors including at least the pre-toned ink is thereby supplied to the ink jet head in the head unit 102.

More specifically, the ink supplying unit 108 is, for example, a portion including the ink container for storing the ink. In this case, use of an ink bottle, an ink pack, and the like, for example, is considered for the ink container. Furthermore, in this case, the ink toned in the ink toning unit 200 (see FIGS. 1A and 1B) is stored in at least the ink container for the pre-toned ink.

The control unit 110 is, for example, a CPU of the shaping device 100, and controls the operation of shaping of the 3D object 50 by controlling each unit of the shaping device 100. The control unit 110, for example, preferably controls each unit of the shaping device 100 based on the shape information, the color image information, and the like of the 3D object to shape. More specifically, in the present example, the shaping device 100 carries out shaping based on slice data received from the control PC 300 (see FIGS. 1A and 1B) to shape the 3D object 50.

Now, a more specific configuration of the head unit 102 will be described. FIG. 2B shows one example of a more detailed configuration of a head unit 102. In the present example, the head unit 102 includes a plurality of ink jet heads 202s, 202mo, 202w, 202x, 202c, 202m, 202y, 202k, 202t (hereinafter referred to as ink jet heads 202s to 202t), a plurality of ultraviolet light sources 204, and a flattening roller 206.

The ink jet heads 202s to 202t are an example of the discharging heads, and discharge the liquid droplet (ink droplet) of the ink supplied from the ink supplying unit 108 through the ink jet method. Furthermore, in the present example, the ink jet heads 202s to 202t are ink jet heads that discharge an ultraviolet curing type ink, and are arranged lined in the main scanning direction (Y direction) with the positions in the sub-scanning direction (X direction) aligned. In this case, the ultraviolet curing type ink is, for example, an ink that cures according to the irradiation of the ultraviolet light. A known ink jet head, for example, can be suitably used for the ink jet heads 202s to 202t. Furthermore, such ink jet heads include a nozzle row, in which a plurality of nozzles are lined in the sub-scanning direction, on a surface facing the shaping table 104. In this case, the nozzles of each ink jet head discharge the ink in the direction toward the shaping table 104.

The arrangement of the ink jet heads 202s to 202t is not limited to the illustrated configuration, and may be variously changed. For example, some ink jet heads may be arranged with the position in the sub-scanning direction shifted with respect to the other ink jet heads. The head unit 102 may further include an ink jet head for other colors. For example, the head unit 102 may further include an ink jet head for various specific colors. Furthermore, the head unit may further include an ink jet head for a light color of each color, as well as, for colors such as R (red), G (green), B (blue), orange.

The ink jet head 202s is an ink jet head that discharges ink containing the material of the support layer 70. A water soluble material that can be dissolved in water after the shaping of the 3D object 50, for example, can be suitably used for the material of the support layer 70. In this case, a material that has a weaker hardness degree by the ultraviolet light and that can be easily decomposed than the material for shaping used for the shaping of the 3D object 50 is preferable. More specifically, a known material for the support layer, for example, can be suitably used for the material of the support layer 70.

The ink jet head 202mo is an ink jet head that discharges a shaping material ink (model material MO) of a predetermined color. The ink jet head 202w is an ink jet head that discharges the white (W) ink.

The ink jet head 202x is an ink jet head that discharges the pre-toned ink toned in the ink toning unit 200. In the present example, the ink jet head 202x discharges the pre-toned ink to form at least one part of the coloring region 58 (see FIGS. 1A and 1B) in the 3D object 50 while coloring the relevant part with the color of the pre-toned ink.

In the illustrated case, the head unit 102 includes only one ink jet head 202x. In an alternative embodiment of the configuration of the shaping device 100, the head unit 102 may include a plurality of ink jet heads 202x. In this case, each of the plurality of ink jet heads 202x may discharge the pre-toned ink toned to colors different from each other.

Each of the plurality of ink jet heads 202c, 202m, 202y, 202k (hereinafter referred to as ink jet heads 202c to 202k) is an ink jet head that discharges the ink of the respective colors of the plurality of basic colors for color representation by color mixing, and respectively discharges the ink of chromatic color of colors different from each other. More specifically, in the present example, each of the ink jet heads 202c to 202k discharges the ink of each color of CMYK. The ink jet heads 202c to 202k thus form at least one part of the portion not colored with the pre-toned ink in the coloring region 58 while carrying out coloring. In the present example, the ink jet heads 202c to 202k are one example of a plurality of color representation heads. Furthermore, the ink jet head 202t is an ink jet head that discharges the clear ink.

The plurality of ultraviolet light sources 204 have a configuration for curing the ink, and generates an ultraviolet light for curing the ultraviolet curing type ink. For example, UVLED (ultraviolet LED), and the like can be suitably used for the ultraviolet light source 204. Use of a metal halide lamp, a mercury lamp, and the like is also considered for the ultraviolet light source 204. In the present example, each of the plurality of ultraviolet light sources 204 is arranged on the one end side and the other end side in the main scanning direction of the head unit 102 so as to have the arrangement of the ink jet heads (ink jet heads 202s to 202t) in between.

The flattening roller 206 is a flattening means for flattening the layer of ink formed during the shaping of the 3D object 50. The flattening roller 206, for example, makes contact with the surface of the layer of ink at the time of the main scanning operation to remove one part of the ink before being cured, thus flattening the layer of ink.

The layer of ink configuring the 3D object 50 can be appropriately formed by using the head unit 102 having the above configuration. The 3D object 50 can be appropriately shaped by forming a plurality of layers of ink in an overlapping manner.

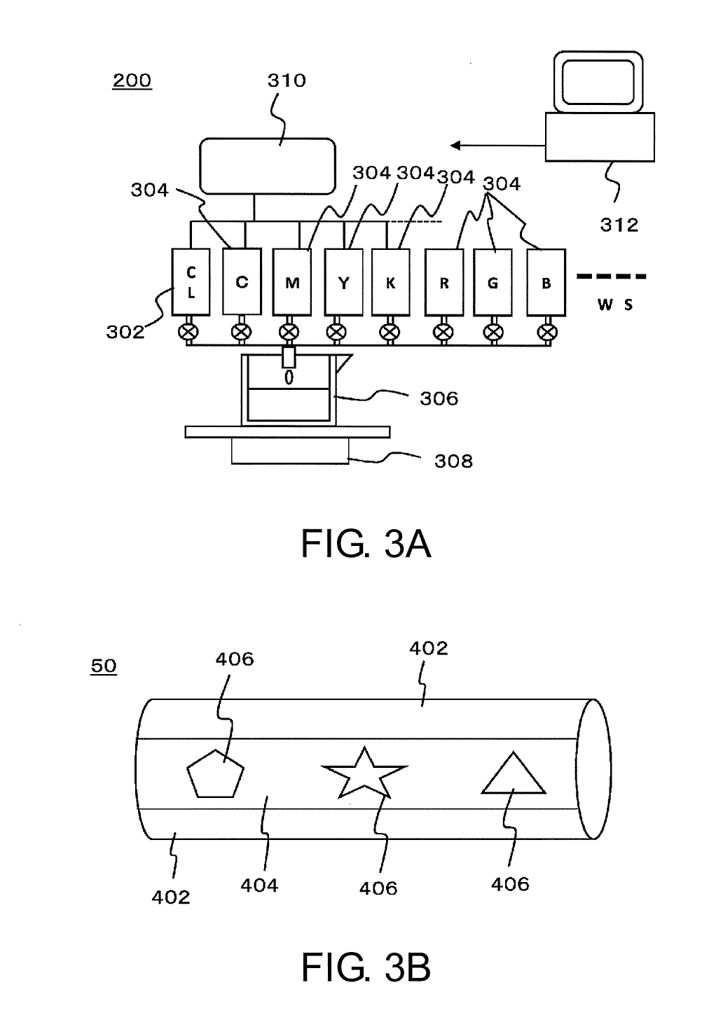

Next, the toning of the ink carried out in the ink toning unit 200 will be described in further detail. FIGS. 3A and 3B are views describing the pre-toned ink in further detail. FIG. 3A shows one example of a configuration of an ink toning unit 200 that carries out the toning of the pre-toned ink. In the present example, the ink toning unit 200 includes a plurality of ink containers 302, 304, a post-preparation ink container 306, a weight measuring unit 308, a toning control unit 310, and a toning control PC 312.

The plurality of ink containers 302, 304 are containers for storing the ink before the toning. In the present example, the ink container 302 of the plurality of ink containers 302, 304 is a container for storing the ink for diluting the density of the color, and stores the clear ink (CL), which is an example of the ink for diluting the density of the color. For example, the density of the color of the pre-toned ink can be appropriately adjusted by using the clear ink. Furthermore, for example, an ink of a light color with low density, and the like can be appropriately manufactured for the pre-toned ink.

The plurality of ink containers 304 are containers (preparation ink container) for storing the ink of the chromatic color used for the adjustment of the color, and stores the ink of each color used for the ink of the basic color of the adjustment of the color. More specifically, in the present example, each of the plurality of ink containers 304 stores the ink of each color of CMYKRGB.

In the present example, the plurality of ink containers 302, 304 include a valve that opens/closes according to the control of the toning control circuit 310, and supply the ink to the post-preparation ink container 306 in response to the instruction of the toning control circuit 310. Thus, each of the plurality of ink containers 302, 304 supplies the ink of an amount specified by the instruction of the toning control circuit 310 to the post-preparation ink container 306.

In an alternative embodiment of the configuration of the ink toning unit 200, the ink toning unit 200 may further include an ink container for an ink of other further colors. For example, an ink container for various specific (S) colors, and the like may be further arranged. In this case, the ink of an arbitrary color (e.g., white, metallic orange, etc.) other than the basic color may be used for the ink of a specific color. Furthermore, in the ink toning unit 200, use of an ink of a color other than the clear ink, and the like is also considered for the ink for diluting the density of the color. For example, use of the white (W) ink, and the like is considered for the ink for diluting the density of the color.

The post-preparation ink container 306 is a container for carrying out the toning of the pre-toned ink, and carries out the toning of the ink by mixing the ink received from each of the plurality of ink containers 302, 304. The weight measuring unit 308 is a measuring means for measuring the weight of the ink in the post-preparation ink container 306, and assists the control of toning by the toning control circuit 310 by transmitting the measured weight to the toning control circuit 310. An electronic scale, and the like, for example, can be suitably used for the weight measuring unit 308.

The toning control circuit 310 is a control circuit that controls the operation of toning, and controls the opening/closing of the valve of each of the plurality of ink containers 302, 304 to adjust the amount of ink to supply from each of the plurality of ink containers 302, 304 to the post-preparation ink container 306. In the present example, the toning control circuit 310 adjusts the ink of the color specified by the toning control PC 312 in response to the instruction received from the toning control PC 312. The toning of the pre-toned ink is thereby carried out.

The toning control PC 312 is a computer that controls the toning of the pre-toned ink, and controls the operation of the toning of the pre-toned ink in accordance with the color to color the 3D object. In this case, the color to color the 3D object may be, for example, any color of a plurality of colors to color the 3D object. Furthermore, in the present example, the toning control PC 312 is a computer different from the control PC 300 (see FIGS. 1A and 1B) in the shaping system 10. In an alternative embodiment of the configuration of the shaping system 10, the control PC 300 of the shaping system 10 may also be used for the toning control PC 312.

By carrying out the adjustment of the color and the density of the ink in the above manner, for example, an ink in which the color is adjusted by color mixing the ink of the color of a plurality of chromatic colors, and in which the density of the color is adjusted by further mixing the ink for diluting the density of the color can be appropriately manufactured. Thus, for example, the pre-toned ink toned in advance in accordance with the color to color the 3D object can be appropriately supplied to the shaping device 100 (see FIGS. 2A and 2B).

A method for toning the pre-toned ink in the ink toning unit 200 will be described in further detail. As described above, in the ink toning unit 200 of the present example, the clear ink and the ink of each color of CMYKRGB is placed in the ink containers 302, 304 and installed. Furthermore, in this case, a structure in which all of the container portion, the valve, and the passage (flow path of the ink) are separated to avoid the mixing of color other than with the ink of the color to use for the toning is adopted for the ink of each color. Furthermore, a configuration of functioning as an individual preparation dispenser for every color is obtained by controlling the opening/closing of each valve of the ink container 302, 304 by the toning control circuit 310. In this case, for example, the function of the preparation dispenser is, for example, a function of supplying the ink of an amount specified by the toning control circuit 310 to the post-preparation ink container 306 by the opening/closing control of the valve.

At the time of execution of the toning, for example, a desired color is first selected from a color sample (color chart) created in advance based on the instruction of the user. Compound data of the ink corresponded in advance with the selected color is then acquired. In this case, the compound data of the ink is, for example, data indicating a compound ratio of the ink of each color of the chromatic color and the density value to be adjusted with the clear ink. The method for selecting the desired color and acquiring the compound data of the ink is not, for example, the method using the color sample, and consideration is also made to measure the color of an object for reference, and the like, and acquire the compound data indicating the relevant color, and the like.

After the acquisition of the compound data of the ink, the amount of each ink to compound is calculated in accordance with the amount of the pre-toned ink scheduled to be created based on the compound data. Then, the opening/closing of each valve of the ink container 304 is controlled by the toning control circuit 310 while managing the amount of ink in the post-preparation ink container 306 by the weight measuring unit 308, so that the ink is taken out from each of the plurality of ink containers 304 to the post-preparation ink container 306 and compounded by a predetermined amount corresponding to the compound data of the ink. The clear ink is added from the ink container 302 to the post-preparation ink container 306 according to the density value in the compound data to adjust the color and the density of the pre-toned ink.

In the present example, the calculation of the amount of each ink at the time of the toning of the pre-toned ink and the control of the opening/closing of the valve are automatically carried out based on the compound data and the amount of pre-toned ink scheduled to create. According to such configuration, for example, the pre-toned ink having the desired color and density can be easily and appropriately toned by the user (end user) of the shaping device 100.

In such a case, consideration is made to carry out the determination, fine adjustment, and the like for the toning, for example, by the manual operation of the user. At the time of the toning of the pre-toned ink, it is preferable to carry out a test of the actual shaping, and the like and check the representing color. In this case, for example, the 3D object, and the like for the test is shaped using the pre-toned ink, and the color of the 3D object is measured to obtain the reproduction color. The desired color and the reproduction color are then compared, and the preparation of the ink is completed if within a color difference ΔE determined in advance. In this case, when desiring to obtain the same color again afterward, the ink of the same color can be reproduced by using the compound data indicating the compound ratio of the same ink.

When ΔE exceeds a constant value, the ink of one or more colors is increased or decreased to adjust the compound to return the shift in color to the desired color, and the toning is again carried out. Thereafter, the color measurement with respect to the shaping effect, the measurement of the ΔE, and the like are again carried out. Such operations are repeated until the ΔE is within the constant value, and the toning is completed when the ΔE becomes within the constant value. According to such configuration, for example, the toning of the pre-color coordinated ink can be appropriately carried out.

FIG. 3B shows one example of a configuration of the 3D object 50 shaped using the pre-toned ink. For the sake of convenience of illustration and explanation, a 3D object 50 having a shape different from the 3D object 50 shown in FIG. 1B is illustrated in FIG. 3B. In the case illustrated in FIG. 3B, the surface of the 3D object 50 is colored separately for a region 402, a region 404, and a plurality of regions 406.

Among such regions, the region 402 is a region colored with the pre-toned ink. In this case, a portion overlapping the region 402 in the coloring region 58 (see FIGS. 1A and 1B) of the 3D object 50 is formed with only the pre-toned ink. The region 404 and the region 406 are regions colored using the ink for coloring other than the pre-toned ink. In this case, a portion overlapping the region 404 and the region 406 in the coloring region 58 of the 3D object 50 is formed using the ink of each color of CMYK and the clear ink.

Here, when carrying out coloring by mixing the inks of a plurality colors such as in the region 404 and the region 406, a difference may arise in the way the color is viewed depending on the position in the 3D object 50 and the observing direction, as will be described later in further detail. As a result, a color variation may occur between the target color and the actually viewed color. In this case, when referring to carrying out coloring by mixing the inks of a plurality of colors, this means, for example, carrying out coloring by discharging the inks of the color different from each other from each of the plurality of ink jet heads. On the other hand, such problem does not substantially arise in the case of a region colored with only the pre-toned ink such as the region 402.

Thus, in the 3D object 50, for example, the important portions, and the like are preferably formed using the pre-toned ink. According to such configuration, for example, a difference can be more appropriately prevented from being produced in the way the color is viewed by the difference in the position in the 3D object 50 and the observing direction for, for example, the important portions, and the like in the 3D object 50. The 3D object 50 thus can be appropriately shaped at high quality.

In this case, various colors can be appropriately represented by forming the other portions using the ink of each color of CMYK, and the like rather than using the pre-toned ink. Thus, for example, the 3D object 50 performed with a wide variety of coloring can be more appropriately shaped at high quality.

The important portion in the 3D object 50 can be considered as, for example, a portion where a widest area is occupied with the same color in the surface of the 3D object 50 such as the region 402 in the configuration shown in FIG. 3B. In this case, considering in a more generalized manner, a region visible area of the largest region in a same color continuous region colored to the color of the pre-toned ink is preferably made greater than a region visible area of the same color continuous region of any other color. In this case, the same color continuous region is, for example, a continuous region colored to the same color in the 3D object 50. The region visible area is, for example, an area that can be visually recognized from the outer side of the 3D object 50 in the same color continuous region.

In the surface of the 3D object 50, for example, the color variation is less likely to stand out, even if it occurs, in a narrow region (narrow line, etc.), and the influence on the quality of the 3D object 50 is small. However, the quality of the 3D object 50 may greatly lower if the color variation occurs in the color occupying a wide area in the surface of the 3D object 50. According to such configuration, for example, the lowering in the quality of the 3D object 50, and the like by the color variation can be appropriately prevented.

The important portion in the 3D object 50 may be considered as, for example, an important portion in terms of designability, for example, irrespective of the size of the area. More specifically, for example, when shaping a figure, which is a 3D object showing a person, and the like, the face of the person can be considered as the important portion. In this case, for example, use of the pre-toned ink toned to show the color of the skin of the person, and the like is considered. According to such configuration, for example, the 3D object 50 such as the figure can be appropriately shaped at high quality.

As also described above in relation to FIGS. 2A and 2B, in an alternative embodiment of the configuration of the shaping device 100, the head unit 102 (see FIGS. 2A and 2B) including a plurality of ink jet heads 202x (see FIGS. 2A and 2B) for pre-toned ink may be used. In this case, for example, the pre-toned ink of a plurality of colors different from each other is used, and different regions are colored with the respective pre-toned inks. More specifically, for example, in the configuration shown in FIG. 3B, consideration is made to color the region 404 different from the region 402 with the pre-toned ink of a color different from the region 402. According to such configuration, for example, the difference can be appropriately prevented from being produced in the way the color is viewed by the difference in the position in the 3D object 50 and the observing direction for more numerous regions.

Now, a supplementary explanation, and the like related to the shaping system 10 of the present example will be made. First, with regards to the case of coloring the 3D object without using the pre-toned ink, the reason the difference is produced in the way the color is viewed by the difference in the position in the 3D object 50 and the observing direction will be described in further detail.

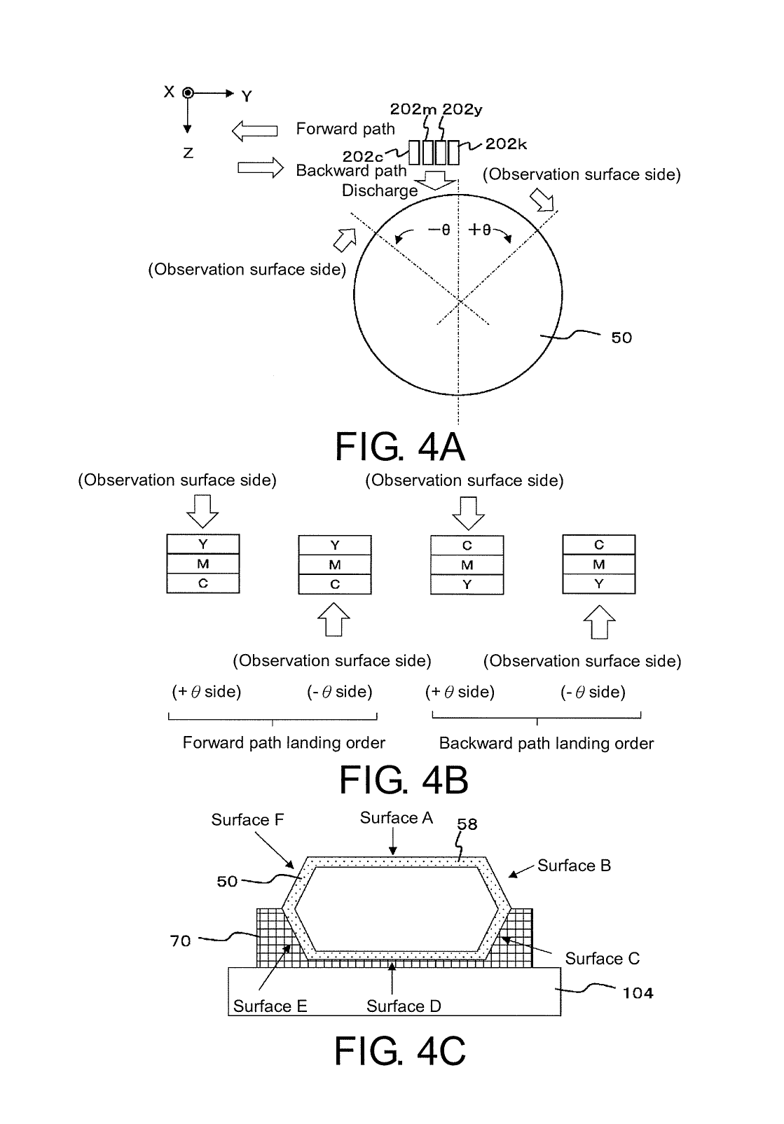

FIGS. 4A to 4C are views describing the way the color is viewed for when color representing by the mixing of the inks of a plurality of colors. FIG. 4A is a view showing one example of an operation of carrying out shaping while coloring using the ink jet heads 202c to 202k for each color of CMYK, and shows one example of a state of shaping the spherical 3D object 50 by carrying out a reciprocate (two-way) main scanning operation in the main scanning direction.

For simplification of the explanation, in FIG. 4A, only the ink jet heads 202y to 202k of the configuration of the shaping device 100 (see FIGS. 2A and 2B) are shown. A state at the time of forming the coloring region is schematically shown with the support layer, and the like formed at the periphery omitted in the 3D object 50.

When color representing by the mixing of the inks of a plurality of colors such as when carrying out the coloring using the ink jet heads 202c to 202k, for example, the ink of each color is discharged from a plurality of ink jet heads to the same position in the 3D object 50 to form a dot of an ink of a different color in an overlapping manner. When the plurality of ink jet heads are arranged lined in the main scanning direction such as the ink jet heads 202c to 202k shown in the figure, the overlapping manner of the dots of the inks becomes reversed by the direction the ink jet heads 202c to 202k are moved at the time of the main scanning operation. In other words, when carrying out the main reciprocate scanning operation, the order the dot of the ink of the different color is overlapped is reversed between the main scanning operation in the forward path and the main scanning operation in the backward path. As a result, the difference arises in the way the color is viewed between the region formed with the main scanning operation of the forward path and the region formed with the main scanning operation of the backward path.

As described above, the three-dimensional 3D object 50 has a possibility of being observed from various directions, as opposed to the two-dimensional printed matter. In this case, the difference is also produced in the way the color is viewed by the order the dot of the ink of the different color is overlapped when viewed from an observation surface side of carrying out the observation. More specifically, for example, if an observation angle θ of observing the colored region in the 3D object 50 is defined as a direction shown in the figure, the observation surface side is reversed between the +θ side and the −θ side, and the difference arises in the way the color is viewed.

FIG. 4B is a view showing one example of a relationship of an overlapping manner of the dot of the ink of the different color, and the way the color is viewed. When the arrangement of the ink jet heads 202c to 202k and the directions of the forward path and the backward path of the main scanning operation are as shown in FIG. 4A, the landing order of the dot of the ink of each color of CMY is overlapped in the order of CMY in order from the bottom in the forward path, and overlapped in the order of YMC in order from the bottom in the backward path. In either overlapping manner of the forward path and the backward path, the order of overlapping of the dot viewed from the observation surface side is reversed between the +θ side and the −θ side, as shown in the figure.

The influence of the color of the dot closest to the observation surface side becomes large in the way the color is viewed. Thus, in the +θ side (0 to 180 degrees), the yellowness becomes stronger in the region formed with the main scanning operation of the forward path, and the blueness becomes stronger in the region formed with the main scanning operation of the backward path. In the −θ side (0 to 180 degrees), the blueness becomes stronger in the region formed with the main scanning operation of the forward path, and the yellowness becomes stronger in the region formed with the main scanning operation of the backward path. As a result, the difference may arise in the way the color is viewed by the difference in the position in the 3D object 50 and the observing direction.

Although the illustration is omitted, in this case, for example, when further overlapping the dot of the K (black) ink, the dot of K is formed on the dot of Y in the forward path, and formed under the dot of Y in the backward path. Thus, when the dot of K is further taken into consideration, the difference may arise in the way the color is viewed by the difference in the position in the 3D object 50 and the observing direction.

Furthermore, such difference in the way the color is viewed also becomes a factor in causing a difference in color tone depending on the surface when, for example, shaping a polyhedral 3D object 50. FIG. 4C is a view showing one example of a configuration of the polyhedral 3D object 50, and shows one example of a state of a cross-section of the 3D object 50 with the support layer 70 and the shaping table 104.

For the sake of convenience of illustration, only the coloring region 58 is shown for the configuration of the cross-section of the 3D object 50. In the case shown in the figure, the surface of the 3D object 50 is formed by a plurality of surfaces including at least surface A to surface F.

In this case, when color representing by color mixing the inks of a plurality of colors, the overlapping manner of the dot of the ink of the different color and the observation surface direction are variously differed by the position of the surface of the 3D object 50, as described above. As a result, a difference arises in the way the color is viewed depending on the surface, and a difference easily arises in the color tone.

On the other hand, when the coloring region 58 of the 3D object 50 is formed with the pre-toned ink, for example, the difference substantially does not arise in the way the color is viewed by the difference in the position in the 3D object 50 and the observing direction. Thus, according to such configuration, the colored 3D object 50 can be more appropriately shaped at high quality, as described above.

When using not only the pre-toned ink but also the ink of each color of CMYK, for example, for the coloring of the 3D object 50, the portion where a wide area is colored with the same color is preferably colored with the pre-toned ink, as also described above. When color representing by color mixing the inks of a plurality of inks, the problem in that the difference is produced in the way the color is viewed by the difference in the position and the observing direction particularly easily arises in the case of a surface inclined with respect to a plane (XY plane) perpendicular to the layering direction such as surface B, surface C, surface E, and surface F shown in the figure. Thus, it is particularly preferable to color even such inclined surface with the pre-toned ink.

Next, the supplementary explanation will be made on the effect obtained by using the pre-toned ink, and the like. When color representing by color mixing the inks of a plurality of colors, the problem of color variation, and the like may occur for reasons other than the reasons described above. Even in such a case, the occurrence of color variation, and the like can be appropriately suppressed by using the pre-toned ink.

More specifically, for example, when shaping the three-dimensional 3D object 50, a difference may arise in the way the color is viewed by the orientation of the plane in the surface of the 3D object 50 by various factors. In this case, for example, the difference may arise in the way the color is viewed between the respective planes of one side and the other side (left and right) in the main scanning direction, one side and the other side (front and back) in the sub-scanning direction, and the one side and the other side (up and down) in the layering direction. Furthermore, in this case, more specifically, for example, a difference may arise in the state of the surface between the upper and lower, and left and right planes caused by the operation of shaping in the layering shaping method, and a difference may be produced in the way the color is viewed.

Furthermore, when color representing by color mixing the inks of a plurality of colors, difference (machine difference) for every device may also arise in the property of color reproduction. In this case, the color variation caused by the machine difference in the property of the color reproduction may occur. The color variation may occur for example by the difference in the adjustment level of the device, and the like.

On the contrary, when using the pre-toned ink, as in the present example, even the color variation caused by such various reasons can also be appropriately suppressed. Furthermore, the colored 3D object 50 thus can be more appropriately shaped.

Using the pre-toned ink is advantageous in terms of adjustment and representation of color. More specifically, for example, if there is a definite color to represent, and the like, the target color may be difficult to reliably represent in the operation of shaping with the method for color representing by color mixing the ink of a plurality of colors. When using the pre-toned ink, on the other hand, for example, the adjustment of the color, and the like may be carried out over sufficient time in advance. Thus, for example, the desired color can be more reliably represented, and the like by using the pre-toned ink. In the case of the method for color representing by color mixing of the ink of a plurality of colors for the representation of color, the color gamut may become narrow compared to when carrying out the two-dimensional printing. Furthermore, for example, the color gamut may become narrow compared to when coloring only the surface in carrying out the coloring up to the interior of the 3D object 50, and the like. When using the pre-toned ink, on the other hand, for example, the degree of freedom in the ratio of mixing the colors becomes larger, and thus the desired color can be more appropriately represented.

Furthermore, the change in color that occurs after the shaping, for example, can also be prevented by using the pre-toned ink. More specifically, for example, when carrying out a post-process, and the like of scraping the surface of the 3D object 50 after carrying out the shaping in the shaping device 100 (see FIGS. 2A and 2B), the change in color may occur by the influence of the post-process if the color is represented by the color mixing of the ink of a plurality of inks. When the coloring is carried out using the pre-toned ink, on the other hand, even such change in color, and the like can be appropriately prevented.

Now, a supplementary explanation will be made on a more specific characteristics of each configuration in the shaping system 10, the alternative embodiment, and the like. As also described above, in the shaping system 10, the toning of the pre-toned ink is carried out by mixing the inks of a plurality of colors in the ink toning unit 200 (see FIGS. 1A and 1B) before the operation of the shaping. In this case, for example, the ink is exposed to air during the operation of mixing the inks, and air may blend into the ink. Thus, in the shaping system 10, for example, a deairing unit of deairing the ink is preferably provided between the ink toning unit 200 and the ink jet head in the shaping device 100.

In this case, for example, consideration is made to use a deairing function type ink supplying unit 108 (see FIGS. 2A and 2B) provided with the configuration for deairing, and the like in the shaping device 100. More specifically, for example, consideration is made to use the configuration including the deairing unit for deairing the ink, the ink container for storing the ink, and the supply path of the ink for the ink supplying unit 108. According to such configuration, for example, the deairing and the temporary holding of the pre-toned ink, for example, can be appropriately carried out in the ink supplying unit 108. Furthermore, for example, the pre-toned ink thus can be more appropriately supplied to the ink jet head.

In the above description, various characteristics have been mainly described focusing on the color of the ink with respect to adjusting the pre-toned ink. However, inks in which the property other than the color is different from each other may be used for the ink mixed at the time of adjustment of the pre-toned ink. In this case, for example, the ink formed by mixing a plurality of inks in which any property other than the color is different from each other is used for the pre-toned ink. Furthermore, in this case, the pre-toned ink may be considered as the ink in which the property other than the color is further adjusted. According to such configuration, for example, even the property other than the color can be appropriately adjusted according to the desired quality. Furthermore, for example, the 3D object of high quality can be more appropriately shaped.

Considering in a more generalized manner, with regards to the characteristic of carrying out the adjustment of ink by mixing the ink beforehand, consideration may be made as the configuration of manufacturing the pre-adjusted ink, which is an ink in which any of the properties is adjusted, focusing on the property other than the color. In this case, in the configuration corresponding to the ink toning unit 200 (e.g., ink adjusting unit), the pre-adjusted ink in which the property is adjusted by mixing a plurality of inks in which any of the properties is different from each other is manufactured. Furthermore, in the shaping device 100, the pre-adjusted ink is supplied to the ink jet head by the ink supplying unit 108. The ink jet head to which the pre-adjusted ink is supplied discharges the pre-adjusted ink to at least one part of the 3D object 50 to be formed in a state in which the property is adjusted. According to such configuration, for example, the 3D object 50 having the desired property can be more reliably shaped.

In such a case, more specifically, for example, in the configuration corresponding to the ink toning unit 200, consideration is made to manufacture the pre-adjusted ink in which the hardness is adjusted so as to obtain the intermediate property of the hard ink and the soft ink by changing the ratio of mixing the hard ink and the soft ink. In this case, for example, the hard ink and the soft ink may be prepared for the ink of the same color, and the hardness may be adjusted without changing the color.

### INDUSTRIAL APPLICABILITY

The present disclosure can be suitably used in, for example, the shaping device.

What is claimed is:

1. A shaping device that shapes a three-dimensional object, the shaping device comprising:
an ink jet head that discharges an ink to become a material of shaping; and
an ink supplying unit that supplies a pre-toned ink, which is the ink toned in advance in accordance with a color to be colored on the three-dimensional object, to the ink jet head, wherein
the ink jet head forms at least one part of the three-dimensional object while coloring the at least one part with the color of the pre-toned ink by discharging the pre-toned ink.

2. The shaping device according to claim 1, wherein the at least one part of the three-dimensional object is formed using only the pre-toned ink.

3. The shaping device according to claim 1, wherein the pre-toned ink is an ink in which a density of a color is further adjusted in accordance with a density of a color to be colored on the three-dimensional object.

4. The shaping device according to claim 3, wherein the pre-toned ink is an ink in which the color is toned by mixing an ink of a color of a plurality of chromatic colors, and in which a density of a color is adjusted by further mixing an ink for diluting the density of the color.

5. The shaping device according to claim 4, wherein the ink for diluting the density of the color is a clear ink.

6. The shaping device according to claim 2, wherein the pre-toned ink is an ink in which a density of a color is further adjusted in accordance with a density of a color to be colored on the three-dimensional object.

7. The shaping device according to claim 6, wherein the pre-toned ink is an ink in which the color is toned by mixing an ink of a color of a plurality of chromatic colors, and in which a density of a color is adjusted by further mixing an ink for diluting the density of the color.

8. The shaping device according to claim 7, wherein the ink for diluting the density of the color is a clear ink.

9. The shaping device according to claim 1, further comprising an ink toning unit that carries out toning of the pre-toned ink using at least an ink of a color of a plurality of chromatic colors.

10. The shaping device according to claim 2, further comprising an ink toning unit that carries out toning of the pre-toned ink using at least an ink of a color of a plurality of chromatic colors.

11. The shaping device according to claim 3, further comprising an ink toning unit that carries out toning of the pre-toned ink using at least an ink of a color of a plurality of chromatic colors.

12. The shaping device according to claim 4, further comprising an ink toning unit that carries out toning of the pre-toned ink using at least an ink of a color of a plurality of chromatic colors.

13. The shaping device according to claim 5, further comprising an ink toning unit that carries out toning of the pre-toned ink using at least an ink of a color of a plurality of chromatic colors.

14. The shaping device according to claim 1, wherein the ink jet head includes:
a pre-toned ink head, which is the ink jet head for discharging the pre-toned ink; and
a plurality of color representation heads, which are a plurality of ink jet heads respectively discharging an ink of a color of each of a plurality of basic colors for color representation by color mixing,
the pre-toned ink head forms the at least one part of the three-dimensional object while coloring the at least one part with the color of the pre-toned ink, and
the plurality of color representation heads form at least another part in the three-dimensional object while coloring the at least another part using the inks of the plurality of basic colors.

15. The shaping device according to claim 14, wherein in the three-dimensional object, a continuous region colored to the same color is defined as a same color continuous region, and when an area visually recognized from an outer side of the three-dimensional object in the same color continuous region is defined as a region visible area, the region visible area of a largest region in the same color continuous region colored to the color of the pre-toned ink is greater than the region visible area of the same color continuous region of any other color.

16. The shaping device according to claim 1, wherein the shaping device shapes a figure which is the three-dimensional object showing a person, and the pre-toned ink is an ink indicating a color of a skin of the person.

17. The shaping device according to claim 1, wherein the pre-toned ink is an ink in which a plurality of inks, in which a property other than color is different from each other, are mixed to further adjust the property other than color.

18. A shaping method for shaping a three-dimensional three-dimensional object, the method comprising the steps of:
supplying a pre-toned ink, which is the ink toned in advance in accordance with a color to be colored on the three-dimensional object, to an ink jet head that discharges an ink to become a material of shaping; and
forming at least one part of the three-dimensional object while coloring the at least one part with a color of the pre-toned ink by discharging the pre-toned ink from the ink jet head.

19. A shaping system that shapes a three-dimensional object, the shaping system comprising:
a shaping device that shapes the three-dimensional object; and
an ink toning unit that carries out toning of an ink, wherein
the shaping device includes:
an ink jet head that discharges an ink to become a material of shaping; and
an ink supplying unit that supplies a pre-toned ink, which is the ink toned in advance in accordance with a color to be colored on the three-dimensional object, to the ink jet head,
the ink toning unit carries out the toning of the pre-toned ink using at least an ink of a color of a plurality of chromatic colors, and
the ink jet head forms at least one part of the three-dimensional object while coloring the at least one part with a color of the pre-toned ink by discharging the pre-toned ink.
